(19) United States
(12) Patent Application Publication
(10) Pub. No.: US 2022/0381273 A1
(43) Pub. Date: Dec. 1, 2022

(54) DOUBLE ECCENTRIC TYPE CONNECTION ASSEMBLY COMPRISING A RING MADE OF DEFORMABLE MATERIAL FOR A CONNECTION BETWEEN TWO STRUCTURES OF AN AIRCRAFT, AND AIRCRAFT COMPRISING SUCH AN ASSEMBLY

(71) Applicant: Airbus Operations SAS, TOULOUSE (FR)

(72) Inventors: Frédéric GOUPIL, TOULOUSE (FR); Vincent FAUCHILLE, TOULOUSE (FR); Laurent POTAUFEUX, TOULOUSE (FR)

(21) Appl. No.: 17/824,115

(22) Filed: May 25, 2022

(30) Foreign Application Priority Data
May 28, 2021 (FR) 2105594

(51) Int. Cl. F16B 5/02; F16B 37/12

(52) U.S. Cl. CPC F16B 5/025; F16B 37/122

(57) ABSTRACT

A connection assembly between two structures, the assembly including an assembly of two eccentric rings, one of which, the external ring, is fitted on the other, being formed as an insert, a bore of the internal ring being configured to fix to one of the structures using a fixing element, and the external ring being accommodated and retained in a through-opening of the other structure, at least one of the eccentric rings being made from a deformable material in order to at least compensate for a play when it is compressed by two retention and compression elements during assembly. Advantageously, it is thus possible to benefit from a mechanical play which facilitates the assembly and to eliminate this play during a tightening operation of the fixing element in order to improve a transfer of loads between the two structures.

### CROSS-REFERENCES TO RELATED APPLICATIONS

This application claims the benefit of the French patent application No. 2105594 filed on May 28, 2021, the entire disclosures of which are incorporated herein by way of reference.

### FIELD OF THE INVENTION

The present invention relates to the assembly of structures, in particular for aircraft. The invention relates more specifically to the assembly of two structures using a connection assembly which uses two eccentric rings, of which one, the external ring, is fitted on the other, internal ring. The invention also relates to an aircraft comprising such a connection assembly between two structures.

### BACKGROUND OF THE INVENTION

It is known to assemble two mechanical structures using an assembly of two eccentric rings, of which one, the external ring, which is accommodated and held in a through-opening of one of the structures, is fitted on the other internal ring; the bore of the internal ring is then provided for fixing to the other of the two structures. Such an assembly enables a double rotation during assembly of a mechanical connection, that is to say, a rotation of the internal eccentric ring in the external eccentric ring, and a rotation of the external eccentric ring in the through-opening of the structure in which it is accommodated. This dual rotation enables compensation for a poor alignment between the longitudinal axis of the bore of the internal ring and the longitudinal axis of a bore in which a fixing element has to be inserted, for example, a screw of a bolt, used to assemble the two structures. This is because, during the production of a bolted fixing between two components, the tolerances of the components and the assembly operations often lead to a misalignment between the two through-holes via which the bolt has to be inserted. The compensation for a poor axial alignment using such an assembly of two eccentric rings can advantageously be carried out in two directions. However, such an assembly leads to the creation of a radial gap which consequently limits the possibility of transferring the radial loads, which brings about a risk of rotation of the eccentric rings and generates wear, impacts and noise.

The situation can therefore be improved.

### SUMMARY OF THE INVENTION

The present invention is intended, in particular, to improve the transfer of radial loads via a mounting assembly which has two eccentric rings (one fitted on the other) and which connects two structures using a fixing element, such as, for example, a bolt.

To this end, the invention relates to a connection assembly between two structures, the connection assembly comprising:
a generally cylindrical or frustoconical insert which has a bore and which is arranged in order to bring about a connection with one of the two structures using a fixing element which comprises a rod which is inserted in the bore, the longitudinal axis of the bore being different from the longitudinal axis of the insert so that the insert is generally in the form of an eccentric ring,

the connection assembly further comprising:
a generally cylindrical or frustoconical eccentric ring which is made of deformable material and which is arranged to be accommodated in a through-opening of the other structure of the two structures, the through-opening of the structure having a shape which complements the external surface generated by revolution of the eccentric ring, the eccentric ring further comprising a through-opening which has a shape which complements the external surface generated by revolution of the insert and which is arranged to accommodate the insert therein, the longitudinal axis of the through-opening of the eccentric ring being aligned or substantially aligned with the longitudinal axis of the insert and the eccentric ring being fitted on the insert so that the assembly of the insert and the eccentric ring constitutes a “double eccentric” fitting in which the eccentric ring is fitted on the insert, which is itself in the form of an eccentric ring, and
two compression elements which extend radially with respect to the longitudinal axis of the through-opening and which each have a through-hole which is configured for the passage of the fixing element and which is, on the one hand, fixedly joined to the other structure or which has an abutment surface with respect to a surface of the other structure, which is perpendicular to the longitudinal axis of the through-opening, and which has, on the other hand, an abutment surface with respect to at least one surface of the insert, perpendicular to the longitudinal axis of the through-opening, the eccentric ring being sized to have a compressed shape when the two compression elements are fixed in an abutment position with respect to the abutment surfaces.

The connection assembly according to the invention may also comprise the following features, taken alone or in combination:
the insert is made from a deformable material and the insert and the eccentric ring extend at one side and the other of the through-opening of the structure beyond a plane which comprises the abutment surfaces.
The bore of the insert and the through-opening of the eccentric ring each comprise a metal tube, the two metal tubes being of an identical length which is less than the length of the insert and the length of the eccentric ring.
The insert is made of metal and has a generally frustoconical shape, and wherein the eccentric ring is made of a deformable material and the through-opening of the eccentric ring has a shape which complements the external surface generated by revolution of the insert.
One, the first one, of the two compression elements is a portion of one of the two structures whose through-hole has a diameter which is less than the diameter of the through-opening of the structure and which forms a stop for the insert and the eccentric ring, and the other of the two compression elements is a washer whose external diameter is greater than the diameter of the through-opening of the structure and whose internal diameter is less than the diameter of the insert and greater than the diameter of the bore of the insert.
The deformable material is an elastomer material.

The invention also relates to an aircraft component which comprises a first structure, a second structure and a connection assembly as described above.

Finally, the invention relates to an aircraft comprising an aircraft component as mentioned above or a connection assembly as described above.

### BRIEF DESCRIPTION OF THE DRAWINGS

The features of the invention mentioned above, and others, will be appreciated more clearly from a reading of the following description of at least one embodiment, the description being given in connection with the appended drawings, in which:

FIG. 1 shows in the same Figure a schematic view which has a plane of section A-A and a section taken along the plane A-A of a connection assembly between two structures which use an eccentric ring which is fitted on another eccentric ring and a bolt (prior to assembly), according to the prior art;

FIG. 2 schematically illustrates, in the same Figure, a connection assembly between two structures which use an eccentric ring which is fitted on another eccentric ring and a bolt, according to a first embodiment, before and after assembly;

FIG. 3 schematically illustrates, in the same Figure, the connection assembly which has already been illustrated in FIG. 2, according to a variant, before and after assembly;

FIG. 4 schematically illustrates, in the same Figure, a variant of the embodiment which has already been illustrated in FIG. 2 and FIG. 3, before and after assembly;

FIG. 5 schematically illustrates a second embodiment; and

FIG. 6 illustrates an aircraft comprising a connection assembly according to an embodiment.

### DETAILED DESCRIPTION OF THE PREFERRED EMBODIMENTS

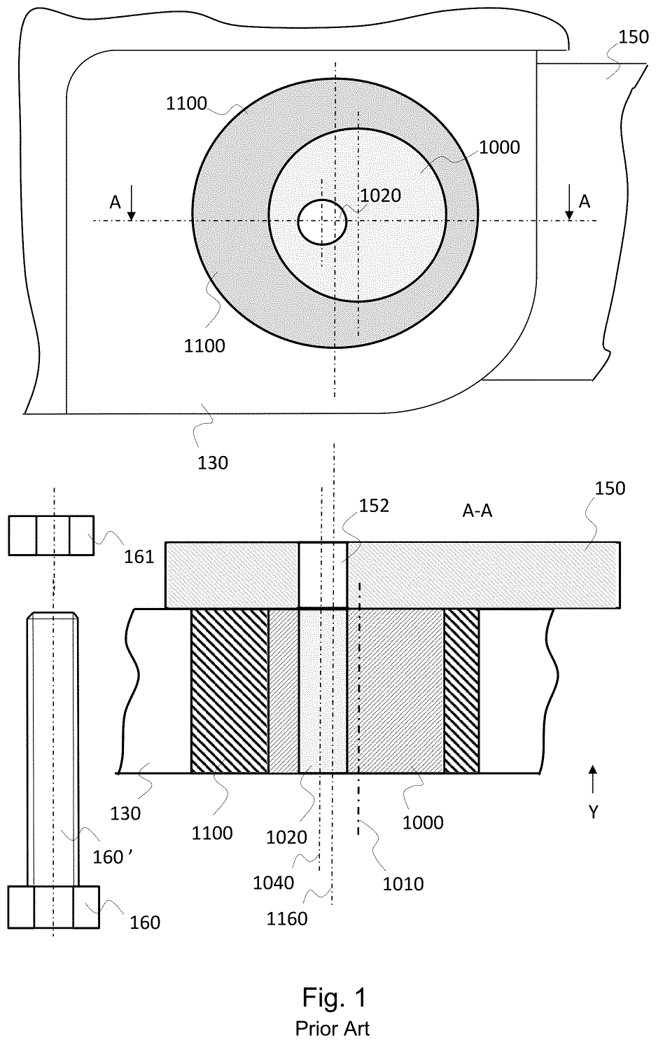

FIG. 1 schematically illustrates a connection assembly between a first structure 150 and a second structure 130 according to the prior art. According to the example described, the structures 130 and 150 are structures of the same aircraft. The upper portion of FIG. 1 illustrates the structures 130 and 150 being moved closer before assembly and the lower portion of FIG. 1 illustrates a plan view of the structures 130 and 150 as a cross section, taken along a plane of section A-A, and a fixing element 160, 161 which is composed of a screw 160 and a nut 161 which is provided to operate a bolted mechanical connection between the structures 130 and 150. In FIG. 1, the structure 130 and 150 are not completely illustrated and only the portions of the structures 130 and 150 which are adjacent to a through-hole which is provided to produce the bolted mechanical connection between the structures and which is arranged in each of the structures are illustrated, respectively. An illustration of the remainder of each of the structures 130 and 150 is not advantageous for understanding the connection assembly described.

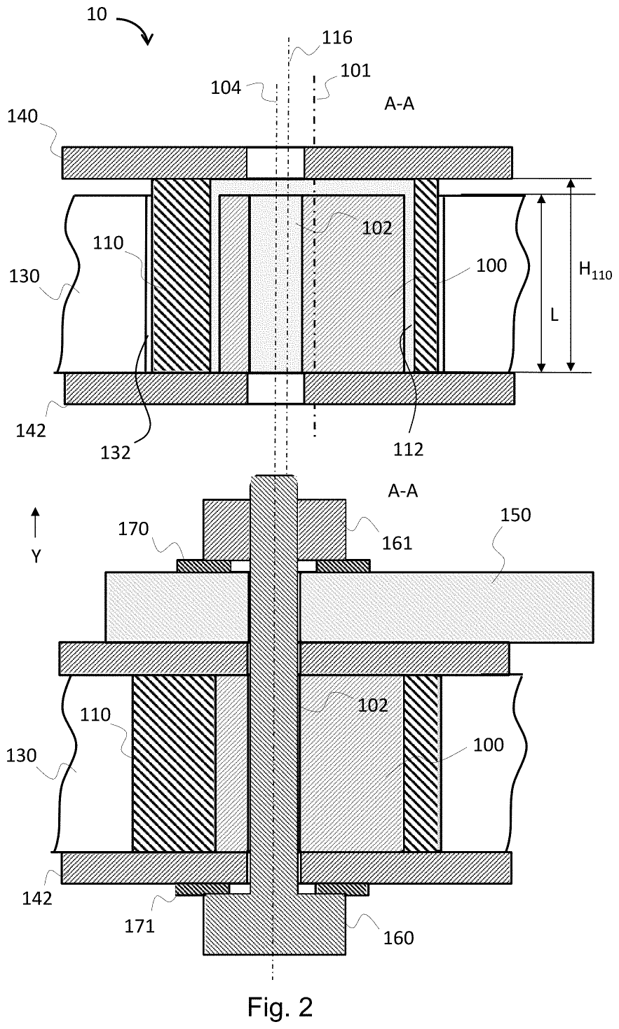

The aircraft structure 130 comprises a through-opening in which a metal eccentric ring 1100 which has a longitudinal axis (or rotation axis) 1160 is accommodated. The eccentric ring 1100 also comprises a through-opening in which there is accommodated a second eccentric metal ring 1000, which has a longitudinal axis (or rotation axis) 1010 and which comprises a bore 1020 which is provided for the insertion of a rod, for example, the rod of a screw of a bolt. The bore 1020 has a longitudinal axis 1040. The assembly of the eccentric ring 1100, referred to as the “external eccentric ring” and the eccentric ring 1000, referred to as the “internal eccentric ring”, constitutes a structure which is sometimes referred to as a “double eccentric” structure and which advantageously enables the bore 1020 of the internal eccentric ring to be moved (and therefore a screw to be inserted into this bore) opposite a bore 152 which is arranged in the structure 150, the bores 1020 and 152 being provided for the connection of the structures 130 and 150 as a result of the fixing element 160, 161, in this instance of the bolt type. It should be noted that the plane of section A-A used for the illustration in the lower portion of FIG. 1 comprises a diameter of the external eccentric ring and a diameter of the internal eccentric ring. The positioning of this plane of section will be further used below in the description of embodiments, from FIG. 2.

As a result of the connection assembly illustrated, the rotation of the internal eccentric ring 1000 in the external eccentric ring 1100, on the one hand, and the rotation of the eccentric ring 1100 in the through-opening of the structure 130, on the other hand, enable a relative positioning of the longitudinal axis 1040 of the bore 1020 and the longitudinal axis of the bore 152 in two directions. When the bores 1020 and 152 are aligned following the rotation of each of the two eccentric rings 1000 and 1100 and the structures 130 and 150 are positioned in predefined positions, the assembly of the structures 130 and 150 is finalized by the insertion of the fixing element 160, in this instance a screw, in the bores 1020 and 152 which are aligned, and to which screw the nut 161 of the bolt composed of the elements 160 and 161 is then screwed. In the assembled configuration, after the bolted connection has been produced, a rod 160′ of the screw 160 occupies the bores 1020 and 152.

Although a misalignment can be eliminated or compensated for in this manner, such a connection assembly has disadvantages, particularly as a result of the presence of occurrences of mechanical play, in terms of transfer of radial loads, vibrations, wear and noise. This is because the assembly and the adjustment of such an assembly require there to be a radial play between the internal eccentric ring and the external eccentric ring, and a radial play between the external eccentric ring and the through-opening of the structure which receives it.

In the remainder of the present description, an internal eccentric ring of a structure of the “double eccentric” type is also referred to as an “insert” in order to improve the legibility and the understanding of the assembly comprising two eccentric rings.

FIG. 2 is a schematic diagram illustrating a mechanical connection assembly 10 comprising a structure of the “double eccentric” type according to a first embodiment. The elements are illustrated in this instance in a section along a plane A-A similar to the one which has already been defined in FIG. 1, that is to say, a plane of section comprising in this instance a diameter of the external eccentric ring 110 and a diameter of the insert 100. The upper portion of FIG. 2 illustrates the mechanical connection assembly 10 prior to assembly (without a bolt), and the lower portion of FIG. 2 illustrates the same mechanical connection assembly 10 after assembly (with the bolt). The connection assembly 10 illustrated is used to bring about a bolted mechanical connection between the aircraft structures 130 and 150 using a bolt 160, 161 which comprises a screw 160 and a nut 161. The connection assembly 10 comprises an insert 100 which has a bore 102. The longitudinal axis 104 of the bore 102 is not aligned with the longitudinal axis (or rotation axis) 101 of the insert 100 so that the insert 100 is generally in the form of an eccentric ring. The insert 100 is inserted into a through-opening 112 of an eccentric ring 110 so that the assembly comprising the eccentric ring 110 and the insert 100 is in the form of a dual eccentric structure in which the eccentric ring 110 is the external eccentric ring and in which the insert 100 is the internal eccentric ring. The eccentric ring 110 has a longitudinal axis (or rotation axis) 116.

Advantageously, the insert 100 is made of metal and the eccentric ring 110 is favorably made from a deformable material which is virtually incompressible and has a height H110 greater than the length L of the through-opening 132 of the structure 130 in which it is accommodated, and the insert 100 has a height which is equal or substantially equal to the length of the through-opening 132 of the structure 130. The height of the insert 100 or the external ring 110 is defined in the present description as generally being the height of a cylinder, that is to say, its dimension along a longitudinal axis, the terminal cross sections being perpendicular to the longitudinal axis of the cylinder. In other words, the eccentric ring 110 extends beyond at least one of the limits of the through-opening 132, and therefore beyond a plane which comprises abutment surfaces (or shoulders) of the structure 130, at the periphery of the through-opening 132. The upper portion of FIG. 2 illustrates such an assembly in which the insert 100 is inserted into the eccentric ring 110, and in which the eccentric ring 110 is inserted into the through-opening 132 of the structure 130. Advantageously, the diameter dimension tolerances of the insert 100 and the eccentric ring 110 are predefined so that occurrences of mechanical play exist and facilitate the insertion of the insert 100 into the eccentric ring 110 and the insertion of the eccentric ring 110 into the through-opening 132 of the structure 130. Furthermore, the tolerances defined in this manner and the occurrences of mechanical play present enable an easy rotation of the insert 100 in the eccentric ring 110 and the eccentric ring 110 in the through-opening 132 of the structure 130 to be produced. Such an assembly substantially facilitates the assembly operations of the mechanical connection between the structure 130 and the structure 150. The main advantage of such a connection assembly, in which the eccentric ring 110 is made from a deformable material which is virtually incompressible, is that, when compression elements 140 and 142 are assembled at one side and the other of the eccentric ring 110 and the insert 100, then are moved closer to each other in abutment with the shoulders of the eccentric ring 110 and the insert 100, the deformable material of the eccentric ring which thus acts in the manner of a spring and which is made of virtually incompressible material deforms and occupies the gaps which are present in order to fill them.

The lower portion of FIG. 2 illustrates the elements which have already been described in the upper portion of this same FIG. 2, in which a bolt, composed of a screw 160 and a nut 161, holds the compression elements 140, 142 which have been moved closer to each other in a direction Y (illustrated by an arrow in FIG. 2) in abutment both against the abutment surfaces of the structure 130 and against the respective shoulders of the eccentric ring 110 and the insert 100. In the example illustrated, a portion of the structure 150 which has a bore is held constrained between a washer 170 against which the nut 161 is screwed to the threaded rod of the screw 160 and the compression element 140. At the other side of the structure 130 (or more specifically a portion of the structure 130), a washer 171 is used in order to provide an abutment surface for the head of the screw 160. In this manner, according to the example described, the compression elements 140 and 142 are large washers and the abutment washers 170 and 171 are washers which have dimensions smaller than those of the washers 140 and 142, these washers performing a function of compression of the deformable material of the eccentric ring 110. Of course, it is possible to dispense with the use of the washers 170 and 171, provided that the diameters of the screw head of the screw 160, the nut 161, the eccentric ring 110 and the insert 100 are arranged so that the bolted connection enables the compression of the eccentric ring 110 which is made from deformable material, between the compression elements 140 and 142, being in this instance, for example, washers with large dimensions. It can be seen in FIG. 2 that all or some of the gaps which are present and which can be seen between the surface of the through-opening 132 and the external surface generated by revolution of the ring 110, on the one hand, and the gaps which are present and which can be seen between the external surface generated by revolution of the insert 100 and the surface of the through-opening 112 of the eccentric ring 110 are filled after tightening the bolted connection and therefore after compression of the compression elements 140 and 142 on the surfaces of the shoulders of the eccentric ring 110, which is deformed in order to fill the occurrences of mechanical play.

Advantageously, this consequently limits relative movements, even weak ones, which could exist between the eccentric ring 110 which acts as an external eccentric ring of a double eccentric structure and the insert 100 which acts itself as an internal eccentric ring of the same double eccentric structure. The wedging which is produced in this manner reduces or eliminates the vibrations, the impacts, the wear and the noise and enables an optimized transfer of radial loads to be carried out between the structures 130 and 150, which is particularly advantageous, for example, in the case of structures of an aircraft. Advantageously, the deformable material of the eccentric ring 110 is an elastomer material, the elastomer material having characteristics of hyper-elasticity and virtual incompressibility which are ideal for the type of deformation desired, with particular regard to the occurrences of mechanical play which exist in a connection assembly comprising a double eccentric structure.

According to one embodiment, the insert 100 is generally cylindrical and the eccentric ring 110 is generally cylindrical.

According to a variant, the insert 100 is generally frustoconical and the through-opening 112 of the eccentric ring 110 has a frustoconical shape which at least partially complements the frustoconical shape of a surface generated by revolution of the insert 100.

According to another variant, the surface of the external ring 110 generated by revolution is frustoconical and the internal surface of the through-opening 132 of the structure 130 has a frustoconical shape which complements the external surface generated by revolution of the eccentric ring 110.

More generally, the described shapes of the through-holes 112, 132 and of the external surfaces generated by revolution may be cylindrical or frustoconical, provided that they enable rotations of the eccentric ring 110 and the insert 100 relative to each other and relative to the structures 130 and 150 in order to carry out an alignment of the bores which receive the fixing element 160, 161. Furthermore, the existing occurrences of mechanical play must be sufficiently large to facilitate the assembly of the connection between the structures 130 and 150 and sufficiently small for the deformation of the deformable material of the eccentric ring to be able to compensate for the occurrences of mechanical play which exist before compression, as a result of the compression elements 140 and 142 which have been moved closer to each other by the tightening action of the nut 161 on the screw 160, or in other words by the tightening effect of the bolted connection.

According to a variant of the embodiment described in relation to FIG. 2, the insert 100 is not made of metal and is also made from virtually incompressible deformable material and also extends beyond the limits of the through-opening 132 of the structure 130 so that it is also subjected itself to such a deformation as to fill the gaps predefined by sizes of the components before deformation of the deformable material, the deformations of the external ring 110 and the insert 100 both being brought about by the compression elements 140 and 142, for example, of the washer type, moving together under the tightening action of the nut 161 on the screw 160.

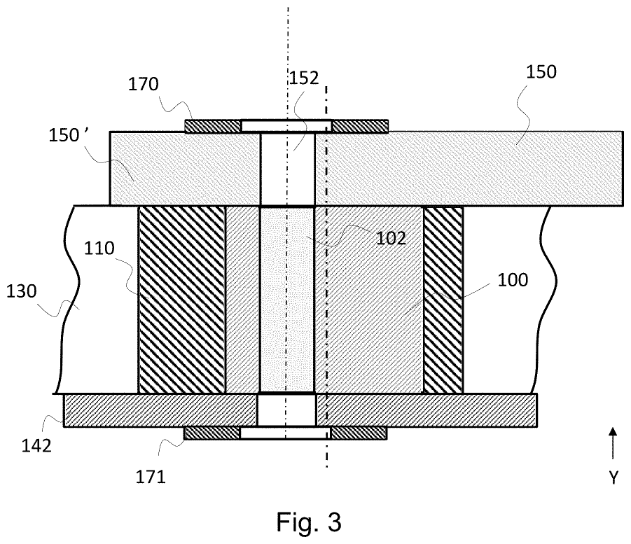

FIG. 3 illustrates a variant of an embodiment according to which the shape of the structure 150 is such that a portion 150′ of the structure 150 which is located at the periphery of the through-hole 152 of the structure 150 which is advantageous for the bolted connection of the structures 130 and 150 acts as a compression element, functionally resembling a large washer. Advantageously, it is thus possible to dispense, for example, with the compression element 140, of the washer type. The deformation of the virtually incompressible deformable material being carried out under the action of the force applied by a portion of the structure 150, on the one hand, and by the compression element, on the other hand

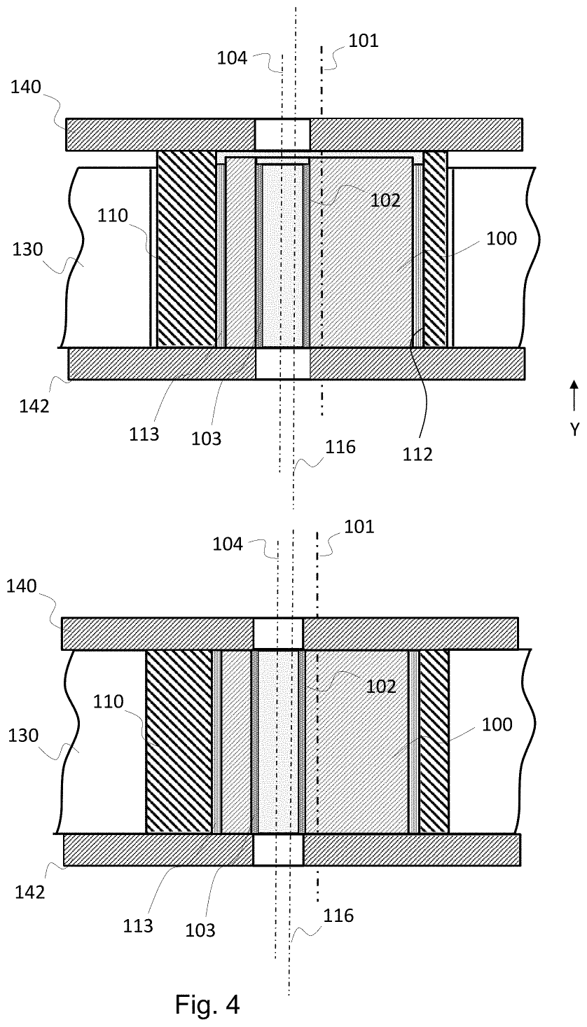

FIG. 4 illustrates another variant of an embodiment, according to which the insert 100 and the eccentric ring 110 are made from virtually incompressible deformable material and which each comprise an internal metal layer which forms a metal tube which is arranged in the bore 102, for the insert 100, and which is arranged in the through-opening 112 for the eccentric ring 110. According to this variant, the elastomer material of the insert 100 and the eccentric ring 110 extends beyond the limits of the through-opening 132 of the structure 130 and the metal tubes of the insert and the eccentric ring extend as far as the limits of the through-opening, or slightly less, so that the compression elements 140 and 142 can abut the abutment surfaces of the structure 130 facing them when the deformable material is compressed under the tightening action of the nut 161 on the screw 160. The upper portion of FIG. 4 illustrates the elements of the connection assembly prior to the nut 161 being tightened on the screw 160 and therefore prior to compression of the deformable material of the eccentric ring 110 and the insert 100. The lower portion of FIG. 4 illustrates the elements of the connection assembly after tightening the nut 161 on the screw 160 and therefore after compression of the deformable material of the eccentric ring 110 and the insert 100. It can be seen that the gaps which are present prior to tightening and which are advantageous for rapid and easy assembly have disappeared after tightening in order to enable optimized transfer of the radial loads between the two structures 130 and 150.

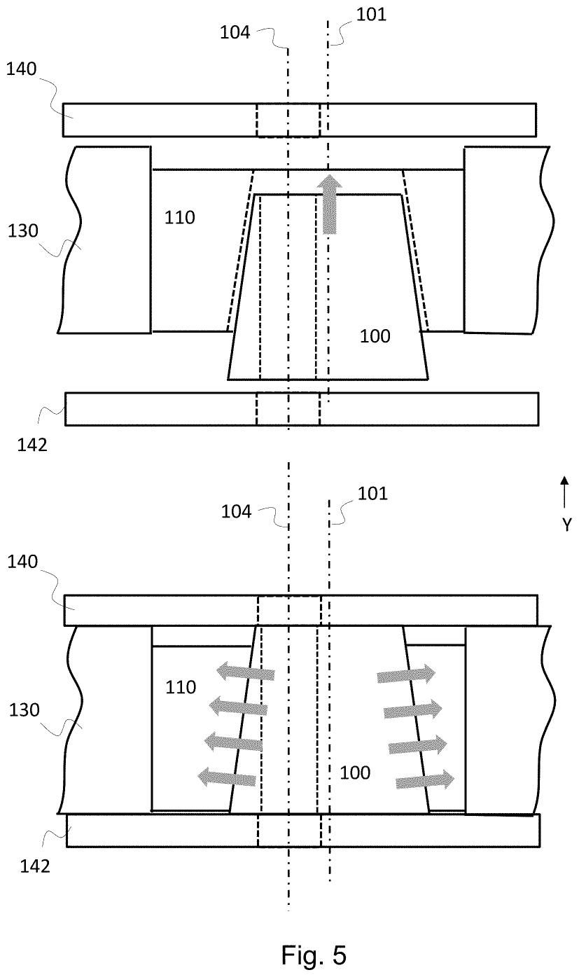

FIG. 5 schematically illustrates a second embodiment according to which the insert 100 is made of metal, is generally frustoconical and the eccentric ring 110 which is generally cylindrical, has a through-opening 112 having a shape which complements the external surface generated by revolution of the insert 100. The complementary shapes of the insert 100 and the through-opening of the eccentric ring 110 are defined so that, when the compression element 142 is moved closer to the compression element 140, the insert moves and is positioned in the through-opening 112 of the eccentric ring 110 in the direction Y and applies a radial or substantially radial pressure (with a radial component) to the surface of the through-opening 112 of the insert 100 which becomes deformed in order to fill the existing gaps before the bolted connection is tightened. Of course, the height of the insert 100 must not exceed, in this configuration, the height of the through-opening 132 of the structure 130 so that the insert 100 can be pushed by the compression element 142, which applies thereto a force in the direction Y, in the frustoconical through-opening of the eccentric ring 110.

According to one embodiment, the compression element 140 may be a portion of the structure 130 (or the structure 150) which forms a stop for the insert 100 and the eccentric ring 110 in the direction Y, and the through-opening 132 of the structure 130 thus resembles a cavity (or a housing) which opens with a smaller diameter in order to enable the passage of the fixing element 160, 161, that is to say, the bolt which is used to bring about the bolted connection.

According to one embodiment, serrations or indentations are arranged on all or some of the abutment surfaces between the elements which are capable of being moved in rotation after the connection has been tightened, and as a result of the torques present, in order to limit any risk of rotation which may be prejudicial to the quality of the bolted connection. For example, indentations may be provided on the shoulders of the eccentric ring 110 and the insert 100 and indentations with a complementary shape may be arranged on abutment surfaces of the compression element 142.

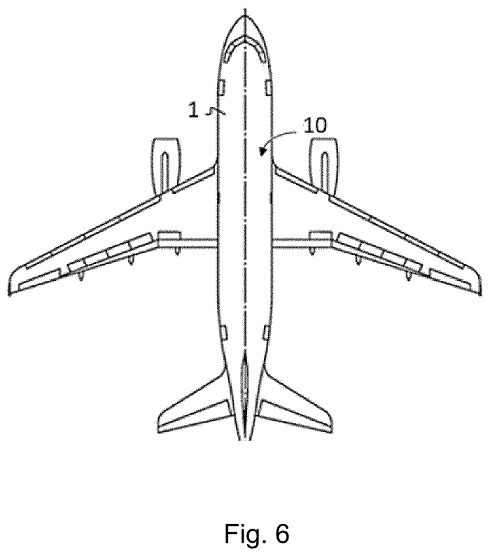

FIG. 6 illustrates an aircraft 1 which comprises at least one connection assembly 10 as described above and which is used to produce a bolted connection between two structures of the aircraft. Several connection assemblies 10 may be used, thus enabling a rapid and easy assembly of the structural elements of the aircraft 1 to be carried out while ensuring an optimized and efficient radial transfer of the loads between the connection structures and substantially limiting the phenomena of noise, wear and friction.

The invention is not limited to only the embodiments and examples described above, but more generally relates to any connection assembly between two structures, in particular aircraft structures, comprising an assembly of two eccentric rings, of which one, the external ring, is fitted on the other, the internal ring, and being in the form of an insert, a bore of the internal ring being arranged for fixing to one of the structures using a fixing element, and the external ring being accommodated and held in a through-opening of the other structure, at least one of the eccentric rings being made from a virtually incompressible deformable material in order to deform and compensate at least for a mechanical play when it is compressed by two retention and compression elements, during assembly.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A connection assembly between two structures, the connection assembly comprising:
a generally cylindrical or frustoconical insert which has a bore and which is configured and arranged to bring about a connection with one of the two structures using a fixing element which comprises a rod which is inserted in the bore, a longitudinal axis of the bore being different from a longitudinal axis of the insert so that the insert is generally in the form of an eccentric ring,
a generally cylindrical or frustoconical eccentric ring which is made of deformable material and which is configured and arranged to be accommodated in a through-opening of a second of the two structures, the through-opening of the second structure having a shape which complements an external surface generated by revolution of the eccentric ring, the eccentric ring further comprising a through-opening which has a shape which complements an external surface generated by revolution of the insert and which is arranged to accommodate the insert therein, a longitudinal axis of the through-opening of the eccentric ring being aligned or substantially aligned with the longitudinal axis of the insert and the eccentric ring being fitted on the insert so that the assembly of the insert and the eccentric ring constitutes a double eccentric fitting in which the eccentric ring is fitted on the insert, which itself is formed as an eccentric ring, and
two compression elements which extend radially with respect to the longitudinal axis of the through-opening and which each have a through-hole which is configured for passage of the fixing element and which is fixedly joined to the other structure or which has an abutment surface with respect to a surface of the other structure, which is perpendicular to the longitudinal axis of the through-opening and which has an abutment surface with respect to at least one surface of the insert, perpendicular to the longitudinal axis of the through-opening, the eccentric ring being sized to have a compressed shape when the two compression elements are fixed in an abutment position with respect to the abutment surfaces.

2. The connection assembly according to claim 1, wherein the insert is made from a deformable material and wherein the insert and the eccentric ring extend at one side and the other of the through-opening beyond a plane which comprises the abutment surfaces.

3. The connection assembly according to claim 2, wherein the bore of the insert and the through-opening of the eccentric ring each comprise a metal tube, the two metal tubes being of an identical length which is less than the length of the insert and the length of the eccentric ring.

4. The connection assembly according to claim 1,
wherein the insert is made of metal and has a generally frustoconical shape, and
wherein the eccentric ring is made of a deformable material and the through-opening of the eccentric ring has a shape which complements the external surface generated by revolution of the insert.

5. The connection assembly according to claim 1, wherein a first one of the two compression elements is a portion of one of the two structures whose through-hole has a diameter which is less than the diameter of the through-opening and which forms a stop for the insert and the eccentric ring, and a second one of the two compression elements is a washer whose external diameter is greater than the diameter of the through-opening and whose internal diameter is less than the diameter of the insert and greater than the diameter of the bore of the insert.

6. The connection assembly according to claim 1, wherein the deformable material is an elastomer material.

7. An aircraft component comprising a first structure, a second structure and a connection assembly according to claim 1.

8. An aircraft comprising a connection assembly according to claim 1.

9. An aircraft comprising an aircraft component according to claim 7.
